(19) United States
(12) Patent Application Publication
(10) Pub. No.: US 2018/0272429 A1
(43) Pub. Date: Sep. 27, 2018

(54) Methods for Additive Manufacturing of a Single Piece Piston

(71) Applicant: DRESSER-RAND COMPANY, Olean, NY (US)

(72) Inventor: Scott J. DELMOTTE, Mansfield, PA (US)

(21) Appl. No.: 15/542,089

(22) PCT Filed: Jan. 26, 2016
(86) PCT No.: PCT/US2016/014828

§ 371 Date: Jul. 7, 2017

Related U.S. Application Data
(60) Provisional application No. 62/112,700, filed on Feb. 6, 2015.

(51) Int. Cl. B22F 7/06; B22F 3/105; B22F 5/00; B22F 5/02; F16J 1/00; B33Y 10/00; B33Y 80/00

(52) U.S. Cl. CPC B22F 7/06; B22F 3/1055; B22F 5/008; B33Y 80/00; F16J 1/001; B33Y 10/00; B22F 5/02

(57) ABSTRACT

A method for fabricating a piston with a layering device via an additive manufacturing process is provided. The method may include forming a first layer of the piston on a substrate with a layering device, forming a second layer of the piston adjacent the first layer with the layering device, and binding the first layer with the second layer. The first layer of the piston may include a first material, and the second layer of the piston may include the first material and a second material.

This application claims priority to U.S. Provisional patent application having Ser. No. 62/112,700, which was filed Feb. 6, 2015. The aforementioned patent application is hereby incorporated by reference in its entirety into the present application to the extent consistent with the present application.

Pistons may often be utilized in a myriad of applications and industrial processes that expose the pistons to extreme operating conditions (e.g., high temperatures, high friction, high mechanical stress, etc.). Accordingly, the pistons may often be fabricated from a plurality of materials to endure these extreme operating conditions. For example, a body of the piston may be fabricated from lightweight materials, and the bores of the piston may be fabricated from bearing materials to facilitate the actuation of the pistons within a piston housing. In another example, piston ring lands may often be fabricated from wear-resistant materials to reduce galling or wearing of the pistons during the actuation thereof. In order to manufacture the pistons from the plurality of materials, respective components or pieces of the piston may often be fabricated separately and subsequently assembled with one another. Separately fabricating each component of the piston, however, may often be time consuming and cost-prohibitive.

While efforts have been made to fabricate the pistons as a single, monolithic piece, these efforts have also proven to be both time consuming and cost-prohibitive. For example, conventional methods of fabricating a single piece piston may include designing a die, fabricating the die, and pressing the piston materials in the die. Further, if additional features (e.g., bores, undercuts, grooves, etc.) are desired in the piston that cannot be achieved by pressing or otherwise consolidating the piston materials in the die, one or more machining and/or shaping processes may often be employed.

What is needed, then, are improved methods for fabricating single-piece pistons.

Embodiments of the disclosure may provide a method for fabricating a piston. The method may include forming a first layer of the piston on a substrate, and forming a second layer of the piston adjacent the first layer. The first layer of the piston may include a first material, and the second layer of the piston may include the first material and a second material. The method may also include binding the first layer of the piston with the second layer of the piston to fabricate the piston.

Embodiments of the disclosure may also provide a method for fabricating a piston with a layering device. The method may include forming a first layer of the piston on a substrate with a layering device, forming a second layer of the piston adjacent the first layer with the layering device, and binding the first layer with the second layer. The first layer may include a first portion of a body of the piston, and the second layer may include a second portion of the body and a portion of a piston ring land of the piston.

Embodiments of the disclosure may further provide a method for fabricating a piston via an additive manufacturing process. The method may include generating a digital model of the piston with a computer aided design assembly. The method may also include partitioning the digital model into at least a first digital cross-section and a second digital cross-section. The method may further include forming a first layer of the piston on a substrate using the first digital cross-section as a first template, and forming the second layer of the piston adjacent the first layer using the second digital cross-section as a second template. The first layer of the piston may include a first portion of the body of the piston, and the second layer may include a second portion of the body and a portion of a piston ring land of the piston. The method may also include binding the first layer with the second layer to fabricate the piston.

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

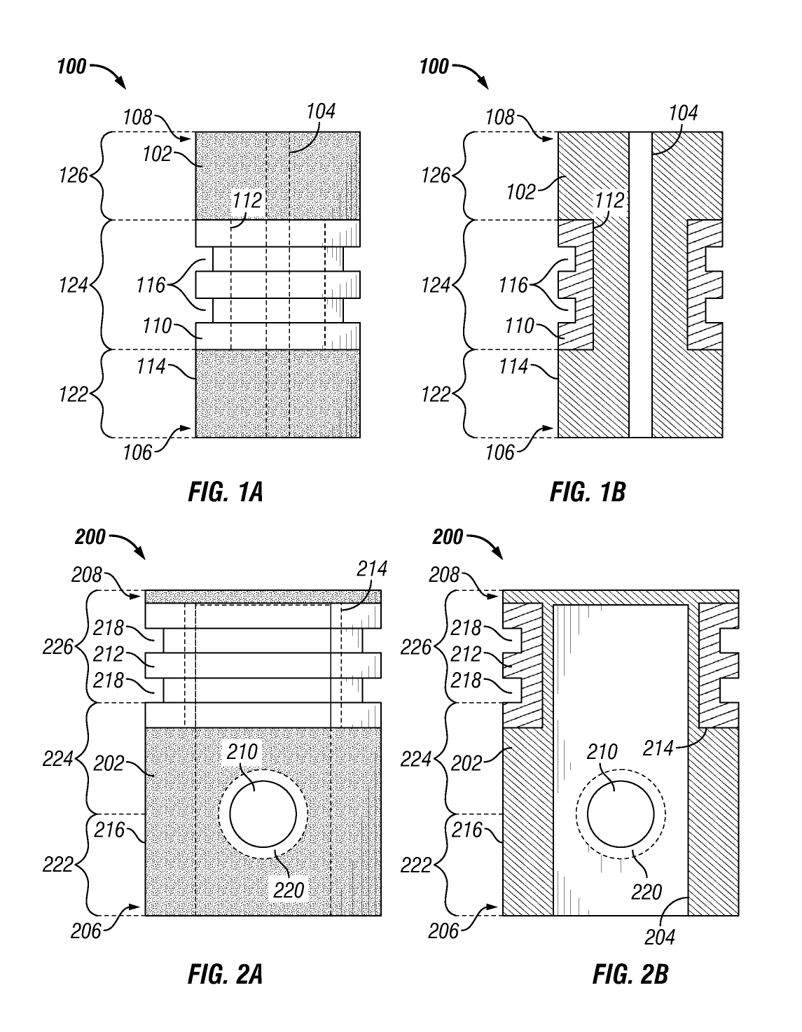

FIG. 1A illustrates a side-view of an exemplary piston that may be fabricated via additive manufacturing, according to one or more embodiments disclosed.

FIG. 1B illustrates a cross-sectional view of the piston of FIG. 1A, according to one or more embodiments disclosed.

FIG. 2A illustrates a side view of another exemplary piston that may be fabricated via additive manufacturing, according to one or more embodiments disclosed.

FIG. 2B illustrates a cross-sectional view of the piston of FIG. 2A, according to one or more embodiments disclosed.

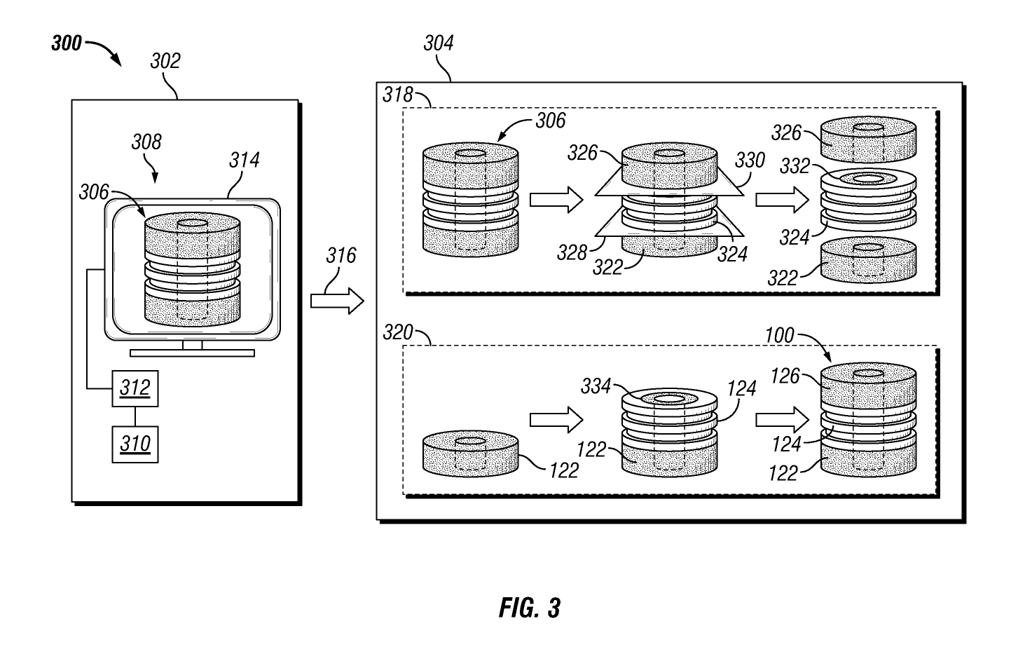

FIG. 3 illustrates a schematic of an exemplary system for fabricating the piston of FIG. 1A via 3D printing, according to one or more embodiments disclosed.

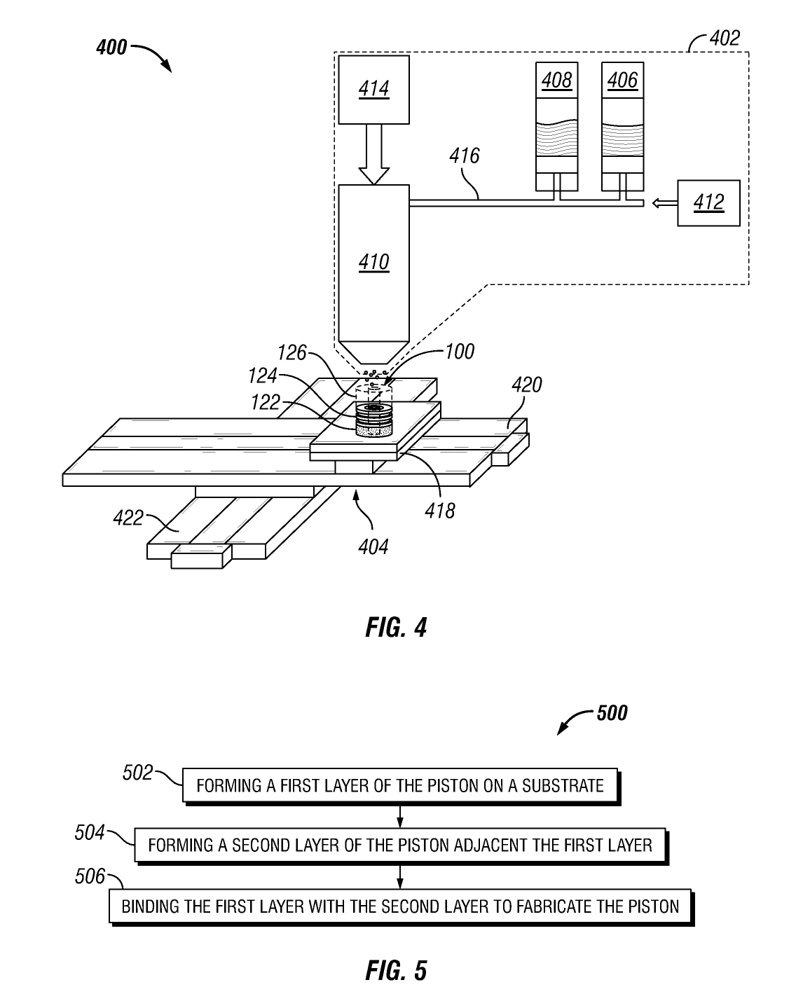

FIG. 4 illustrates an exemplary layering device that may be utilized in the system of FIG. 3, according to one or more embodiments disclosed.

FIG. 5 illustrates a flowchart of a method for fabricating a piston, according to one or more embodiments disclosed.

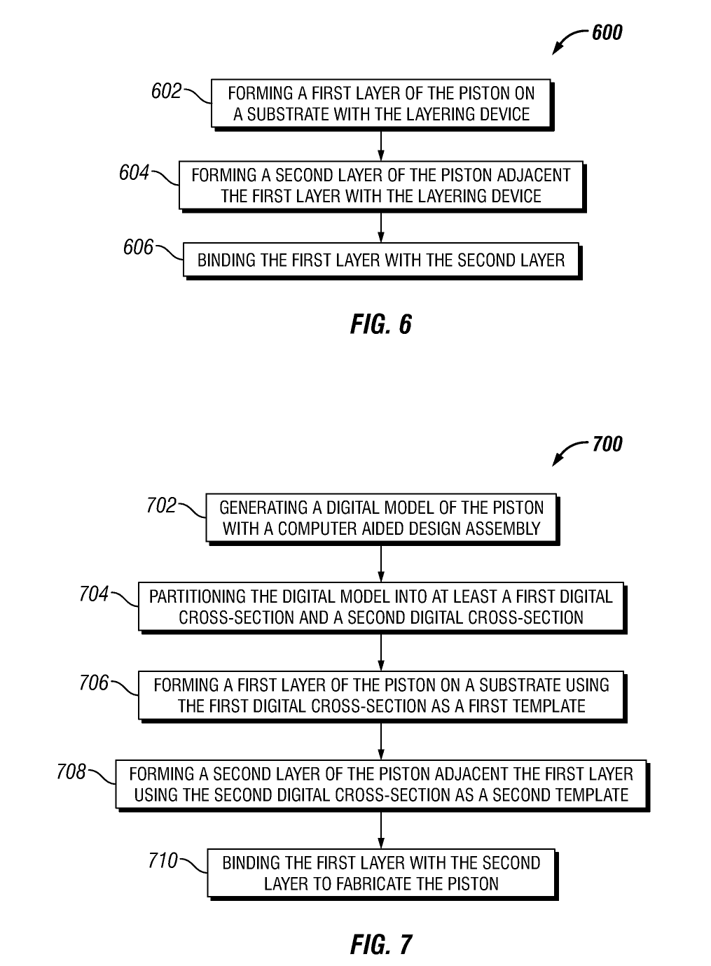

FIG. 6 illustrates a flowchart of a method for fabricating a piston with a layering device, according to one or more embodiments disclosed.

FIG. 7 illustrates a flowchart of a method for fabricating a piston via an additive manufacturing process, according to one or more embodiments disclosed.

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

FIGS. 1A and 1B illustrate a side view and a cross-sectional view, respectively, of an exemplary piston 100 that may be fabricated via additive manufacturing, according to one or more embodiments. Additive manufacturing or three-dimensional (3D) printing is a process of fabricating a 3D object or article (e.g., the piston 100) from a digital design or model of the 3D article. As further described herein, 3D printing may include separating or slicing the digital model of the piston 100 into multiple layers, and generating a tool path for each of the multiple layers. An additive manufacturing device or system (e.g., 3D printer) may utilize the tool path of each of the multiple layers and a feedstock (e.g., powdered materials) to fabricate the piston 100 in a layer-by-layer manner.

The piston 100 fabricated via additive manufacturing may be utilized in a compressor (e.g., reciprocating compressor), an engine, a pump, or the like. For example, the piston 100 may be disposed in a piston cylinder (not shown) of a reciprocating compressor (not shown) to compress a fluid contained therein. The piston 100 may include a generally cylindrical body 102 configured to be disposed in the piston cylinder (not shown). As illustrated in FIGS. 1A and 1B, the body 102 may define a bore 104 extending between opposing first and second axial end portions 106, 108 thereof. The bore 104 may be configured to receive a piston rod (not shown) to couple the piston 100 with one or more components of the compressor, the engine, and/or the pump. For example, the bore 104 may be configured to receive the piston rod to couple the piston 100 to a crankshaft (not shown) of the reciprocating compressor. As further illustrated in FIGS. 1A and 1B, the body 102 may define a recess 112 extending from an outer radial surface 114 toward the bore 104. The recess 112 may also extend annularly about the circumference of the body 102.

The piston 100 may include a piston ring land 110 defining one or more grooves (two are shown 116). In an exemplary embodiment, respective piston rings (not shown) may be disposed in the grooves 116 and configured to provide a fluid tight seal between the piston 100 and the piston cylinder (not shown). As illustrated in FIGS. 1A and 1B, the piston ring land 110 may be disposed in the recess 112 formed between the first axial end portion 106 and the second axial end portion 108 of the body 102. The piston ring land 110 may extend annularly about the circumference of the piston 100. As further illustrated in FIGS. 1A and 1B, the grooves 116 may extend annularly about the circumference of the piston ring land 110.

FIGS. 2A and 2B illustrate a side-view and a cross-sectional view, respectively, of another exemplary piston 200 that may be fabricated via additive manufacturing, according to one or more embodiments. The piston 200, similar to the piston 100 illustrated in FIGS. 1A and 1B, may be utilized in a compressor (e.g., reciprocating compressor), an engine, a pump, or the like. For example, the piston 200 may be disposed in a piston cylinder (not shown) of a reciprocating compressor (not shown) to compress the process fluid contained therein. The piston 200 may include a generally cylindrical body 202 configured to be disposed in the piston cylinder (not shown). As illustrated in FIGS. 2A and 2B, the body 202 may define a bore 204 at least partially extending from a first axial end portion 206 toward a second axial end portion 208 thereof. As further illustrated in FIGS. 2A and 2B, the body 202 may also define an opening 210 extending through at least a portion thereof. The opening 210 may be configured to receive a mechanical fastener (not shown), such as a piston pin, to couple the piston 200 with a pivoting piston rod (not shown).

The piston 200, similar to the piston 100 illustrated in FIGS. 1A and 1B, may include a piston ring land 212 defining one or more grooves (two are shown 218). Piston rings (not shown) may be disposed in the respective grooves 218 and configured to provide a fluid tight seal between the piston 200 and the piston cylinder (not shown). The piston ring land 212 may be disposed in a recess 214 formed between the first axial end portion 206 and the second axial end portion 208 of the body 202. In an exemplary embodiment, illustrated in FIGS. 2A and 2B, the piston ring land 212 may be disposed near or proximal the second axial end portion 208 of the body 202. The piston ring land 212 may also extend annularly about the circumference of the piston 200. The grooves (two are shown 218) may extend annularly about the circumference of the piston ring land 212.

Each of the pistons 100, 200 described above may be fabricated as a single or monolithic piece via 3D printing. For example, referring to FIG. 1A, the piston ring land 110 and the body 102 of the piston 100 may be fabricated as a monolithic piece. In another example, the piston ring land 110 and the body 102 of the piston 100 may be integrally formed with one another to fabricate the piston 100. Similarly, referring to FIG. 2A, the piston ring land 212 and the body 202 of the piston 200 may be fabricated as a monolithic piece. Additionally, the piston ring land 212 and the body 202 of the piston 200 may be integrally formed with one another to fabricate the piston 200. Accordingly, the piston ring lands 110, 212 and the respective bodies 102, 202 of the pistons 100, 200 may be formed or coupled with one another without any mechanical fasteners (e.g., screws, bolts, nuts, clamps, etc.). It should be appreciated that omitting the mechanical fasteners may reduce a relative weight of the pistons 100, 200. It should further be appreciated that fabricating the pistons 100, 200 via 3D printing may reduce manufacturing lead times by eliminating one or more assembly processes.

Each of the pistons 100, 200 described above may also be fabricated from two or more materials via 3D printing. Each of the materials forming the pistons 100, 200 may have the same or different properties. For example, each of the materials may be or include a wear resistant material, a heat resistant material, a bearing material, an anti-scuffing material, a corrosion resistant material, a relatively lightweight material, or the like, or any combination thereof. Illustrative wear resistant materials may include, but are not limited to, nitrides (e.g., titanium nitride, chromium nitride, etc.), carbides, chromium, ceramics, cermets, steel, bronze, iron, or the like. Illustrative heat resistant materials may include, but are not limited to, steel (e.g., austenitic steel), alloys, superalloys (e.g., nickel or chromium based superalloys), or the like. Illustrative bearing materials may include, but are not limited to, copper-based alloys, aluminum/copper based alloys, tin alloys, zinc alloys, or the like, or any combination thereof. The bearing materials may be relatively hard metallic bearing materials including, but not limited to, brass, aluminum bronze, zinc-based bronze, tin-based bronze, or the like. The bearing materials may also be relatively soft metallic bearing materials including, but not limited to, lead-based Babbitt, aluminum/tin alloys, aluminum-zinc alloys, or the like. The bearing materials may include one or more metals and one or more non-metals (e.g., graphite, molybdenum sulfide, etc.). Illustrative corrosion resistant materials may include, but are not limited to, TiB₂, ZrB₂, TiC, Si₃N₄, Y₂O₃, La₂O₃, or the like. As used herein, “lightweight materials,” may include metals and metal alloys having a density relatively less than steel. Illustrative lightweight materials may include, but are not limited to, titanium, aluminum, magnesium, zinc, vanadium, or the like, or any alloy thereof. In at least one embodiment, each of the materials (e.g., a wear resistant material, a heat resistant material, a bearing material, an anti-scuffing material, a corrosion resistant material, a relatively lightweight material, etc.) may be or include one or more metals, one or more metalloids, one or more non-metals (e.g., ceramics), one or more additives, or any combination or compounds thereof. For example, one or more of the materials may be or include a composite material containing the metal, the metalloids, the non-metals, and/or the additives.

In at least one embodiment, referring to FIG. 1A, a first portion of the piston 100 and a second portion of the piston 100 may be fabricated from a different material. For example, the piston ring land 110 of the piston 100 may be fabricated from a first material (e.g., a wear resistant material), and the body 102 of the piston 100 may be fabricated from a second material (e.g., a relatively lightweight material). Similarly, referring to FIG. 2A, the piston ring land 212 of the piston 200 may be fabricated from a first material (e.g., a wear resistant material), and the body 202 of the piston 200 may be fabricated from a second material (e.g., a relatively lightweight material). In another embodiment, the body 202 or the piston ring land 212 of the piston 200 may be fabricated from two or more materials. For example, referring to FIGS. 2A and 2B, a portion 220 (illustrated in phantom) of the body 202 defining the opening 210 may be fabricated from a first material (e.g., a bearing material), and the remaining portions of the body 202 may be fabricated from a second material (e.g., a relatively lightweight material). In another example, the second end portion 208 of the piston 200 may be fabricated from a first material (e.g., a heat resistant material), and the remaining portions of the body 202 may be fabricated from a second material (e.g., a relatively lightweight material).

Each of the pistons 100, 200 described above may include a plurality of layers fused, bound, or otherwise coupled with one another. For example, the piston 100 illustrated in FIGS. 1A and 1B may include a first layer 122, a second layer 124, and a third layer 126 coupled with one another. Similarly, the piston 200 illustrated in FIGS. 2A and 2B may include a first layer 222, a second layer 224, and a third layer 226 coupled with one another. For simplicity, only three layers 122, 124, 126, 222, 224, 226 are shown for each of the pistons 100, 200. It should be appreciated, however, that each of the pistons 100, 200 may include any number of layers. For example, each of the pistons 100, 200 may include about 2, about 3, about 4, about 5, about 10, or about 15 to about 20, about 30, about 40, about 50, about 150, about 200, about 250, about 300, about 400, about 500, or more layers coupled with one another.

The layers 122, 124, 126 of the piston 100 illustrated in FIGS. 1A and 1B may include or be fabricated from one or more materials (e.g., a wear resistant material, a heat resistant material, a bearing material, an anti-scuffing material, a corrosion resistant material, a relatively lightweight material, etc.). For example, as illustrated in FIG. 1B, the first layer 122 of the piston 100 may include a first material, the second layer 124 of the piston 100 may include the first material and a second material, and the third layer 126 of the piston 100 may include the first material. The layers 122, 124, 126 of the piston 100 and the materials forming the layers 122, 124, 126 may be formed from one or more metals, one or more metalloids, one or more non-metals, one or more additives, or any combination or compounds thereof. It should be appreciated that the layers 222, 224, 226 of the piston 200 illustrated in FIGS. 2A and 2B may also include or be fabricated from one or more materials (e.g., a wear resistant material, a heat resistant material, a bearing material, an anti-scuffing material, a corrosion resistant material, a relatively lightweight material, etc.). Further, the layers 222, 224, 226 of the piston 200 and the materials forming the layers 222, 224, 226 may be formed from one or more metals, one or more metalloids, one or more non-metals, one or more additives, or any combination or compounds thereof.

The metals may be or include, but are not limited to, one or more alkali metals, one or more alkaline earth metals, one or more transition metals, one or more post-transition metals, or any mixtures, alloys, or compounds thereof. Illustrative transition metals may include, but are not limited to, chromium, iron, cobalt, molybdenum, tungsten, tantalum, titanium, zirconium, niobium, rhenium, yttrium, vanadium, hafnium, or any mixtures, alloys, or compounds thereof. Illustrative metals may also be or include, but are not limited to, aluminum, iron, titanium, or the like, or any combination thereof. The metals may also be or include metal alloys and superalloys, such as stainless steel, carbon steel, a nickel-based superalloy, a cobalt-based superalloy, or the like, or any combination thereof. The one or more metalloids may be or include, but are not limited to, boron, silicon, antimony, or any mixtures or compounds thereof.

The non-metals may be or include, but are not limited to, carbon, sulfur, phosphorus, or the like, or any mixtures or compounds thereof. For example, the non-metals may include carbon black, graphite, carbon nanomaterials, or the like, or any combination thereof. The one or more non-metals may also be or include one or more polymers or polymeric materials. Illustrative polymers may include, but are not limited to, polyester, epoxy, polyimide, polyetheretherketone (PEEK), polypropylene, or the like, or any combination thereof.

The additives may be or include, but are not limited to, one or more lubricants. The lubricants may be configured to increase flow and/or reduce friction during the fabrication of each of the pistons 100, 200. For example, the lubricants may be combined with the metals, the metalloids, and/or the non-metals and configured to reduce friction between the metals, the metalloids, and/or the non-metals during one or more fabrication processes (e.g., pressing, compaction, alloying, etc.). In another example, the lubricants may be or form a coating on the metals, the metalloids, and/or the non-metals, and the coating may be configured to reduce friction between the metals, the metalloids, and/or the non-metals during the one or more fabrication processes. Illustrative lubricants may include, but are not limited to, one or more organic compounds such as stearic acid, stearin, metallic stearates, or the like, or any combination thereof.

The additives may also be or include, but are not limited to, one or more binders. The binders may be configured to combine, couple, and/or agglomerate the metals, the metalloids, and/or the non-metals with one another. For example, the binder may be configured to facilitate the agglomeration of the metals, the metalloids, and/or the non-metals with one another to form a feedstock (e.g., a powdered material) that may be utilized in the fabrication of each of the pistons 100, 200. In another example, the binder may be configured to facilitate the binding of the metals, the metalloids, and/or the non-metals with one another to form the one or more materials (e.g., a wear resistant material, a heat resistant material, a bearing material, an anti-scuffing material, a corrosion resistant material, a relatively lightweight material, etc.) of the respective layers 122, 124, 126, 222, 224, 226 of each of the pistons 100, 200. The binders may be or include one or more metallic binders, inorganic binders, organic binders, or any combination thereof. Illustrative metallic binders may include, but are not limited to, any one or more transition metals including, but not limited to, magnesium, ruthenium, osmium, iron, cobalt, nickel, copper, molybdenum, tantalum, tungsten, rhenium, or any mixtures, compounds, or alloys thereof. The metallic binders may also include, but are not limited to, any alkali metals including, but not limited to, lithium, sodium, potassium, rubidium, cesium, or any mixtures, compounds, or alloys thereof. Illustrative organic binders may be or include, but are not limited to, one or more waxes or resins that are insoluble, or at least substantially insoluble, in water. Waxes may include, for example, animal waxes, vegetable waxes, mineral waxes, synthetic waxes, or any combination thereof. The additives of the powdered materials may further include one or more oxidation resistance additives.

FIG. 3 illustrates a schematic of an exemplary system 300 for fabricating a piston via 3D printing, according to one or more embodiments. In particular, FIG. 3 illustrates the system 300 being utilized in the fabrication of the piston 100 of FIGS. 1A and 1B; however, in other embodiments, the piston 200 of FIGS. 2A and 2B may be fabricated via the system 300. As illustrated in FIG. 3, the system 300 may include a computer aided design (CAD) assembly 302 and a layering device 304. The CAD assembly 302 may include any software capable of providing or generating a geometry or digital model 306 of the piston 100 in three dimensions. As further described herein, the layering device 304 may utilize the digital model 306 as a template or guide to fabricate the piston 100 in a layer-by-layer manner. The layering device 304 may be or include any device (e.g., 3D printer) capable of fabricating the piston 100 using the digital model 306 as a template. Illustrative layering devices may include, but are not limited to, PROJET® 1000, PROJET® 1500, PROJET® SD 3500, PROJET® HD 3500, PROJET® HD 3500PLUS, PROJET® 3500 HDMAX, PROJET® CP 3500, PROJET® CPX 3500, PROJET® CPX 3500PLUS, PROJET® 3500 CPXMAX, PROJET® 7000, PROJET® 6000, PROJET® 5000, PROJET® DP 3500, PROJET® MP 3500, ZPRINTER® 150, ZPRINTER® 250, ZPRINTER® 350, ZPRINTER® 450, ZPRINTER® 650, ZPRINTER® 850, ProX® 500, sPro® 140, sPro® 60 HD, sPro® 230, ProX® 100, ProX® 200, and/or ProX® 300, which are all commercially available from 3D Systems Corp. of Rock Hill, S.C. Illustrative layering devices may also include, but are not limited to, EOSINT® M 280, EOS® M 290, EOS® M 400, and/or PRECIOUS® M 080, which are all commercially available from EOS of North America, Inc. of Novi, Mich. The layering devices may further include an AM250 laser melting machine commercially available from Renishaw Inc. of Hoffman Estates, Ill.

The CAD assembly 302 may include at least one computer 308 having at least one memory 310 (e.g., hard drives, random access memory, flash memory, etc.), one or more central processing units (one is shown 312), one or more input devices (e.g., keyboard and mouse) (not shown), one or more monitors 314 on which a software application can be executed, or any combination thereof. The memory 310 may store an operating system and/or any programs or software capable of providing or generating the digital model 306. The central processing unit 312 may work in concert with the memory 310 and/or the input devices (not shown) to perform tasks for a user or operator. The central processing unit 312 may be automated or may execute commands at the direction of the user. The computer 308 may interface with one or more databases, support computers or processors, the Internet, or any combination thereof. It may be appreciated that the term “interface” may refer to all possible internal and/or external interfaces, wired or wireless. While FIG. 3 illustrates the computer 308 as a platform on which the methods discussed and described herein may be performed, the methods may also be performed on any other platform or device having computing capabilities. For example, the layering device 304 may include a platform or device capable of generating the digital model 306.

The digital model 306 may include information or data defining one or more portions of the piston 100. For example, the digital model 306 may include 3D numerical coordinates of an entire geometry of the piston 100. The digital model 306 may define an inner surface, an outer surface, and/or a volume of the piston 100 to be fabricated by the layering device 304. The digital model 306 may be communicated to the layering device 304, as illustrated by arrow 316, and may provide the template to fabricate the piston 100.

The layering device 304 may fabricate the piston 100 from the digital model 306 in one or more processes (two are shown 318, 320). A first process 318 for fabricating the piston 100 from the digital model 306 may be or include a digital process. The digital process 318 may include dividing or partitioning the digital model 306 into two or more digital layers or digital cross-sections (three are shown 322, 324, 326) using one or more digital horizontal planes (two are shown 328, 330). For example, as illustrated in FIG. 3, the digital process 318 may include partitioning the digital model 306 into successive digital cross-sections 322, 324, 326, which may be two dimensional (2D) or 3D. It may be appreciated that the layering device 304 may divide or partition the digital model 306 into any number of digital cross-sections 322, 324, 326 using any number of digital horizontal planes 328, 330.

Each of the digital cross-sections 322, 324, 326 may provide a template to fabricate at least a portion of the piston 100. For example, as illustrated in FIG. 3, each of the digital cross-sections 322, 324, 326 may provide a template to fabricate each of the layers 122, 124, 126 of the piston 100 in a second process 320. The digital cross-sections 322, 324, 326 may include data defining the respective layers 122, 124, 126 of the piston 100. For example, a first digital cross-section 322 may include data defining the first layer 122 of the piston 100, a second digital cross-section 324 may include data defining the second layer 124 of the piston 100, and a third digital cross-section 326 may include data defining the third layer 126 of the piston 100. Each of the digital cross-sections 322, 324, 326 may include data defining an outer cross-sectional line, an inner cross-sectional line, a cross-sectional area, a volume, or any combination thereof. The respective inner cross-sectional line and outer cross-sectional line of each of the digital cross-sections 322, 324, 326 may define a respective inner surface and a respective outer surface of each of the layers 122, 124, 126 of the piston 100. Further, the respective cross-sectional area of each of the digital cross-sections 322, 324, 326 may at least partially define a respective volume of each of the layers 122, 124, 26 of the piston 100. Each of the digital cross-sections 322, 324, 326 may also include data defining one or more cross-sectional lines (one is shown 332) separating the respective materials of each of the layers 122, 124, 126. For example, the second digital cross-section 324 may define a cross-sectional line 332 that separates the first material from the second material. The cross-sectional line 332 may define an interface or border 334 extending between the respective materials of each of the layers 122, 124, 126. For example, as illustrated in FIG. 3, the cross-sectional line 332 of the second digital cross-section 324 may define the interface 334 extending between the first material and the second material of the second layer 124 of the piston 100.

As previously discussed, the layering device 304 may fabricate the piston 100 from the digital model 306 in one or more processes 318, 320, and the digital process 318 may include partitioning the digital model 306 into the digital cross-sections 322, 324, 326. The second process 320 for fabricating the piston 100 from the digital model 306 may include fabricating each of the layers 122, 124, 126 of the piston 100 in a layer-by-layer manner. For example, the second process 320 may include sequentially forming each of the layers 122, 124, 126 of the piston 100 using the respective digital cross-sections 322, 324, 326 as a template. The second process 320 may also include binding the layers 122, 124, 126 with one another to build or form the piston 100. Any number of layers 122, 124, 126 may be formed and/or bound with one another to form the piston 100.

In an exemplary operation, illustrated in FIG. 3, the layering device 304 may at least partially fabricate the piston 100 by forming the first layer 122, the second layer 124, and the third layer 126, and combining or binding the first, second, and third layers 122, 124, 126 with one another. The first layer 122 may be formed on a substrate (not shown) configured to support the first layer 122 and any subsequent layers. Any one or more of the layers 122, 124, 126 formed by the layering device 304 may provide or be a substrate for any subsequent layers deposited by the layering device 100. For example, the first layer 122 deposited by the layering device 304 may be or provide the substrate for the second layer 124 or any subsequent layers. In another example, the second layer 124 may be or provide the substrate for the third layer 126 or any subsequent layers. In at least one embodiment, the formation of at least one of the layers 122, 124, 126 and the binding of the at least one of the layers 122, 124, 126 with another one of the layers 122, 124, 126 may occur simultaneously. For example, the formation of the second layer 124 may at least partially bind the second layer 124 with the first layer 122. Similarly, the formation of the third layer 126 adjacent the second layer 124 may at least partially bind the third layer 126 with the second layer 124. In another embodiment, the formation of at least one of the layers 122, 124, 126 and the binding of the at least one of the layers 122, 124, 126 with another one of the layers 122, 124, 126 may occur sequentially. For example, the second layer 124 may be formed adjacent or atop the first layer 122 in one process, and the second layer 124 may be bound, fused, or otherwise coupled with the first layer 122 in a subsequent process (e.g., a heating process, a pressing process, etc.). Similarly, the third layer 126 may be formed adjacent the second layer 124 in one process, and the third layer 126 may be coupled with the second layer 124 in a subsequent process. The layering device 304 may bind or fuse the first layer 122, the second layer 124, the third layer 126, and/or any subsequent layers (not shown) with one another to fabricate the piston 100.

The formation and binding of the first layer 122, the second layer 124, the third layer 126, and/or any subsequent layers (not shown) may include any additive manufacturing process known in the art. For example, the formation and binding of the layers 122, 124, 126 may include a direct metal laser fusion (DMLF) process or a modification thereof. DMLF may include precision melting and solidification of a build material (e.g., the feedstock) into each of the successive layers 122, 124, 126. In another example, the formation and binding of the layers 122, 124, 126 may include a direct metal laser sintering (DMLS) process or a modification thereof. In yet another example, the formation and binding of the layers 122, 124, 126 may include a direct metal deposition (DMD) process or a modification thereof. In another example, the formation and binding of the layers 122, 124, 126 may include a laser engineered net shaping (LENS) process or a modification thereof. The LENS process may include delivering a build material (e.g., the feedstock) into a path (e.g., energy beam) of a high powered laser to form a molten pool of the powdered material, and solidifying the molten pool to form each of the layers 122, 124, 126.

FIG. 4 illustrates an exemplary layering device 400 that may be utilized in the system 300 of FIG. 3, according to one or more embodiments. The layering device 400 may be configured to form and/or bind the layers 122, 124, 126 of the piston 100 (see FIG. 1A and FIG. 3) with one another to form the piston 100. For example, the layering device 400 may be configured to deposit successive layers 122, 124, 126 of one or more molten materials onto a substrate 418 and/or any one or more of the layers 122, 124, 126 of the piston 100, and bind the layers 122, 124, 126 with one another to form the piston 100.

As illustrated in FIG. 4, the layering device 400 may include a fabrication assembly 402 and a stage 404 (e.g., an x,y-axis stage). The fabrication assembly 402 may include one or more feeders (two are shown 406, 408), a deposition nozzle 410, a gas supply 412, a heat source (e.g., laser) 414, or any combination thereof. Each of the feeders 406, 408 may be configured to retain and dispense one or more of the materials used to fabricate the piston 100. For example, a first feeder 406 may contain the first material used to fabricate the piston 100 and be configured to deliver the first material to a conduit 416 fluidly coupled therewith. Similarly, a second feeder 408 may contain the second material used to fabricate the piston 100 and be configured to deliver the second material to the conduit 416 fluidly coupled therewith. In at least one embodiment, the dispensing of the first material and/or the second material from the first feeder 406 and/or the second feeder 408, respectively, may occur substantially simultaneously. In another embodiment, the dispensing of the first material and/or the second material from the first feeder 406 and/or the second feeder 408, respectively, may occur sequentially.

The first material and/or the second material may be dispensed from the first feeder 406 and/or the second feeder 408, respectively, at a controlled rate and subsequently mixed with a gas (e.g., inert gas) from the gas supply 412. The gas from the gas supply 412 may carry or feed the first material and/or the second material to the deposition nozzle 410 via the conduit 416. The first and/or second materials may be dispensed from the deposition nozzle 410 and melted by the laser 414 or an energy beam thereof to form a first molten material and/or a second molten material, and the first and/or the second molten materials may be deposited onto the substrate 418 to form each of the layers 122, 124, 126 of the piston 100. The dispensing of the first and/or second materials from the deposition nozzle 410, the melting of the first and/or second materials by the laser 414, and/or the deposition of the molten first and/or the second molten material may occur substantially simultaneously or sequentially.

As the first and second materials are deposited, the stage 404 may be translated or moved in a desired pattern to form each of the layers 122, 124, 126 of the piston 100. The desired pattern may be determined, at least in part, by the digital model 306 (see FIG. 3). The stage 404 may be configured to move the substrate in at least two dimensions. For example, the stage 404 may include an X-axis track 420 and a Y-axis track 422 configured to move the substrate 418 along an X-axis and a Y-axis, respectively. In at least one embodiment, the deposition nozzle 410 and/or the stage 404 may be configured to move along a Z-axis. For example, the stage 404 may be configured to move along the Z-axis to raise or lower the substrate 418 relative to the deposition nozzle 410.

As previously discussed, with reference to FIG. 1B, each of the layers 122, 24, 126 of the piston 100 may include one or more materials. For example, the second layer 124 of the piston 100 may include the first material, forming at least a portion of the piston ring land 110, and the second material, forming at least a portion of the body 102. Accordingly, the layering device 400 may be configured to dispense and melt the first material to form at least a portion of the piston ring land 110 of the piston 100, and may further be configured to dispense and melt the second material to form at least a portion of the body 102 of the piston 100.

FIG. 5 illustrates a flowchart of a method 500 for fabricating a piston, according to one or more embodiments. The method 500 may include forming a first layer of the piston on a substrate, as shown at 502. The first layer may include or be fabricated from a first material. The method 500 may also include forming a second layer of the piston adjacent the first layer, as shown at 504. The second layer may include or be fabricated from the first material and a second material. The method 500 may further include binding the first layer with the second layer to fabricate the piston, as shown at 506.

FIG. 6 illustrates a flowchart of a method 600 for fabricating a piston with a layering device, according to one or more embodiments. The method 600 may include forming a first layer of the piston on a substrate with the layering device, as shown at 602. The first layer may include a first portion of a body of the piston. The method 600 may also include forming a second layer of the piston adjacent the first layer with the layering device, as shown at 604. The second layer may include a second portion of the body and a portion of a piston ring land of the piston. The method 600 may further include binding the first layer with the second layer, as shown at 606.

FIG. 7 illustrates a flowchart of a method 700 for fabricating a piston via an additive manufacturing process, according to one or more embodiments. The method 700 may include generating a digital model of the piston with a computer aided design assembly, as shown at 702. The method 700 may also include partitioning the digital model into at least a first digital cross-section and a second digital cross-section, as shown at 704. The method 700 may further include forming a first layer of the piston on a substrate using the first digital cross-section as a first template, as shown at 706. The first layer may include a first portion of a body of the piston. The method 700 may also include forming a second layer of the piston adjacent the first layer using the second digital cross-section as a second template, as shown at 708. The second layer may include a second portion of the body and a portion of a piston ring land of the piston. The method 700 may also include binding the first layer with the second layer to fabricate the piston, as shown at 710.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

I claim:

1. A method for fabricating a piston, comprising:
forming a first layer of the piston on a substrate, the first layer comprising a first material;
forming a second layer of the piston adjacent the first layer, the second layer comprising the first material and a second material; and
binding the first layer with the second layer to fabricate the piston.

2. The method of claim 1, wherein forming the first layer of the piston on the substrate comprises:
melting the first material to a first molten material with a heat source; and
cooling the first molten material to form the first layer of the piston.

3. The method of claim 1, wherein forming the second layer of the piston adjacent the first layer comprises:
melting the first material to a first molten material with a heat source;
cooling the first molten material to form a first portion of the second layer;
melting the second material to a second molten material with the heat source; and
cooling the second molten material to form a second portion of the second layer.

4. The method of claim 1, wherein the first layer defines a first portion of a bore extending axially through the piston, and the second layer defines a second portion of the bore.

5. The method of claim 1, wherein the first material comprises a wear-resistant material or a bearing material.

6. The method of claim 1, wherein the second material comprises a heat-resistant material or a lightweight material.

7. A method for fabricating a piston with a layering device, comprising:
forming a first layer of the piston on a substrate with the layering device, the first layer comprising a first portion of a body of the piston;
forming a second layer of the piston adjacent the first layer with the layering device, the second layer comprising a second portion of the body and a portion of a piston ring land of the piston; and
binding the first layer with the second layer.

8. The method of claim 7, wherein the body of the piston comprises a lightweight material.

9. The method of claim 7, wherein the piston ring land comprises a wear-resistant material.

10. The method of claim 7, wherein the second portion of the body and the portion of the piston ring land are integrally formed with one another.

11. The method of claim 10, wherein the body of the piston comprises a lightweight material, and the piston ring land comprises a wear-resistant material.

12. The method claim 7, wherein forming the first layer of the piston on the substrate with the layering device comprises:
melting a first material with a heat source; and
cooling the first material to form the first portion of the body.

13. The method of claim 7, wherein forming the second layer of the piston adjacent the first layer comprises:
melting a first material with a heat source;
cooling the first material to form the second portion of the body;
melting a second material with the heat source; and
cooling the second material to form the portion of the piston ring land.

14. The method of claim 13, wherein the body of the piston comprises a lightweight material and a bearing material, and the piston ring land comprises a wear-resistant material.

15. A method for fabricating a piston via an additive manufacturing process, comprising:
generating a digital model of the piston with a computer aided design assembly;
partitioning the digital model into at least a first digital cross-section and a second digital cross-section;
forming a first layer of the piston on a substrate using the first digital cross-section as a first template, the first layer comprising a first portion of a body of the piston;
forming a second layer of the piston adjacent the first layer using the second digital cross-section as a second template, the second layer comprising a second portion of the body and a portion of a piston ring land of the piston; and
binding the first layer with the second layer to fabricate the piston.

16. The method of claim 15, wherein forming the first layer of the piston on the substrate using the first digital cross-section as the first template comprises:
melting a first material with a heat source; and
cooling the first material to form the first portion of the body.

17. The method of claim 16, wherein forming the second layer of the piston adjacent the first layer using the second digital cross-section as the second template comprises:
melting the first material with the heat source;
cooling the first material to form the second portion of the body;
melting a second material with the heat source; and
cooling the second material to form the portion of the piston ring land.

18. The method of claim 17, wherein the second digital cross-section defines an interface between the second portion of the body and the portion of the piston ring land.

19. The method of claim 18, wherein the second portion of the body and the portion of the piston ring land are integrally formed with one another.

20. The method of claim 19, wherein the first material is a lightweight material, and the second material is a wear-resistant material.
